(19) United States
(12) Patent Application Publication
(10) Pub. No.: US 2026/0063486 A1
(43) Pub. Date: Mar. 5, 2026

(54) ADDITIVE MANUFACTURING TESTING APPARATUSES AND METHODS FOR USING SAME IN MEASURING TENSILE AND COMPRESSIVE LOADS

(71) Applicant: General Electric Company, Evendale, OH (US)

(72) Inventors: Cathleen Ann Hoel, Schenectady, NY (US); Charles Corey Graff, Broadalbin, NY (US); William Costakis, Clifton Park, NY (US); Kathleen Ann Maleski-Yadeski, Bennington, VT (US); Kevin R. Dickson, Dayton, OH (US)

(73) Assignee: General Electric Company, Evendale, OH (US)

(21) Appl. No.: 18/822,781

(22) Filed: Sep. 3, 2024

(51) Int. Cl. B29C 64/245; B29C 64/205; B29C 64/286

(52) U.S. Cl. CPC G01L 5/0076; G01N 3/08; B29C 64/205; B29C 64/245; B29C 64/286

(57) ABSTRACT

An additive manufacturing testing apparatus including an interchangeable base plate, an interchangeable dolly, and a sensor. The interchangeable base plate includes a transparent section over which a photocurable material is disposed. The interchangeable dolly is positionable between an upper position and a lower position along a vertical axis. The interchangeable dolly is configured to compress the photocurable material between the transparent section and the interchangeable dolly and configured to retract from the transparent section. The sensor is coupled to the interchangeable dolly. The sensor is configured to measure tensile load and compressive load during movement of the interchangeable dolly between the upper position and the lower position along the vertical axis during compression of the photocurable material and retraction of the interchangeable dolly from the transparent section.

### FIELD

The subject matter disclosed herein relates to additive manufacturing and, more specifically, to additive manufacturing testing apparatuses and methods for measuring tensile and compressive loads of a photocurable material.

### BACKGROUND

Additive manufacturing, also known as 3D printing, generally involves printing an article one layer at a time using specialized systems. For example, vat polymerization employs a two-dimensional image projector to build components one layer at a time. For each layer, the projector flashes a radiation image of the cross-section of the component on the surface of the liquid or through a transparent object which defines a constrained surface of a photocurable material. Exposure to the radiation cures and solidifies the pattern in the material and joins it to a previously cured layer.

### BRIEF DESCRIPTION OF THE DRAWINGS

FIG. 1 schematically depicts a front view of an additive manufacturing testing apparatus, according to one or more embodiments shown and described herein;

FIG. 2 schematically depicts a perspective view of the additive manufacturing testing apparatus illustrated in FIG. 1 including a photocurable material;

FIG. 3 schematically depicts a perspective view of the additive manufacturing testing apparatus illustrated in FIG. 1 illustrating an interchangeable dolly contacting the photocurable material;

FIG. 4 schematically depicts a cross sectional view of a load train, according to one or more embodiments shown and described herein;

FIG. 5 schematically depicts a cross sectional view of a quick connect insert, according to one or more embodiments shown and described herein;

FIG. 6 schematically depicts a method of measuring load and compressive load of a photocurable material, according to one or more embodiments shown and described herein; and

FIG. 7 is a plot of load (y-axis; in Newtons (N)) versus displacement (x-axis; in millimeters (mm)) of the interchangeable dolly.

### DETAILED DESCRIPTION

Reference will now be made in detail to various embodiments of additive manufacturing testing apparatuses and methods for measuring tensile and compressive loads of a photocurable material.

In particular, various embodiments of an additive manufacturing testing apparatus include an interchangeable base plate, an interchangeable dolly, and a sensor. The interchangeable base plate may comprise a transparent section over which a photocurable material is disposed. The interchangeable dolly is positionable between an upper position and a lower position along a vertical axis. The interchangeable dolly is configured to compress the photocurable material between the transparent section and the interchangeable dolly and configured to retract from the transparent section. The sensor is coupled to the interchangeable dolly. The sensor is configured to measure tensile load and compressive load during movement of the interchangeable dolly between the upper position and the lower position along the vertical axis during compression of the photocurable material and retraction of the interchangeable dolly from the transparent section.

In embodiments, a method of measuring tensile load and compressive load of a photocurable material includes disposing the photocurable material on an interchangeable base plate; compressing the photocurable material with an interchangeable dolly coupled to a sensor configured to measure tensile load and compressive load; retracting the interchangeable dolly from the interchangeable base plate; and continuously measuring tensile load and compressive load by the sensor during compression of the photocurable material with the interchangeable dolly and retraction of the interchangeable dolly.

Various embodiments of additive manufacturing testing apparatuses and methods for using same will be referred to herein with specific reference to the appended drawings.

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein, for example, up, down, right, left, front, back, top, bottom are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation; and the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As described herein, vat polymerization employs a light source to form a two dimensional image to build components. “Vat polymerization” encompasses using a vat of liquid photopolymer material to construct a model layer by layer. A vat polymerization apparatus may include a transparent substrate, a projector positioned beneath the transparent substrate, and a build plate attached to a stage that moves vertically up and down relative to the transparent substrate. An uncured photocurable material is disposed as a layer having a desired thickness onto the transparent substrate. The build plate lowers onto the uncured photocurable material, compressing it between the substrate and the build plate and defining a layer thickness. Radiant energy from the projector is used to cure the photocurable material through the transparent substrate. Once the curing is complete, the stage is retracted upwards along with the build plate, taking the cured layer with the build plate. The substrate is then advanced to expose additional uncured photocurable material in a subsequent, new cycle.

Adhesive forces may cause stresses within the photocurable material or between the photocurable material and substrate as the stage is retracted. Unacceptably high adhesive forces may lead to failure modes or defects in the photocurable material, such as cracking or distortion. The components and parameters of the vat polymerization apparatus and the composition and properties of the photocurable material being cured therein, either individually or in combination, may contribute to such adhesive forces. Conventional testing apparatuses directed to evaluating failure modes or defects in using vat polymerization apparatuses may not be equipped to provide various measurements, such as measuring both tensile force and compressive force. Moreover, such conventional testing apparatuses may not provide flexibility in testing the different factors that lead to failure.

To address these concerns, embodiments of the additive manufacturing testing apparatus disclosed and described herein include an interchangeable base plate, an interchangeable dolly, and a sensor. The additive manufacturing testing apparatus may measure tensile and compressive forces during movement of the interchangeable dolly. The additive manufacturing testing apparatus may also provide flexibility in testing the factors that lead to adhesive forces and, ultimately defects or failure. For example, the following factors, by example and without limitation, may be interchanged or adjusted and subjected to testing in the additive manufacturing testing apparatus disclosed and described herein to evaluate their contributions to adhesive forces: (1) composition and thickness of photocurable material; (2) rate of displacement as the dolly moves towards and into the photocurable material and retraction of interchangeable dolly; (3) size, shape, and composition of contact surface of interchangeable dolly; (4) properties (e.g., tension), material, and thickness of interchangeable transparent substrate; and (5) coupling of interchangeable transparent substrate to interchangeable base plate.

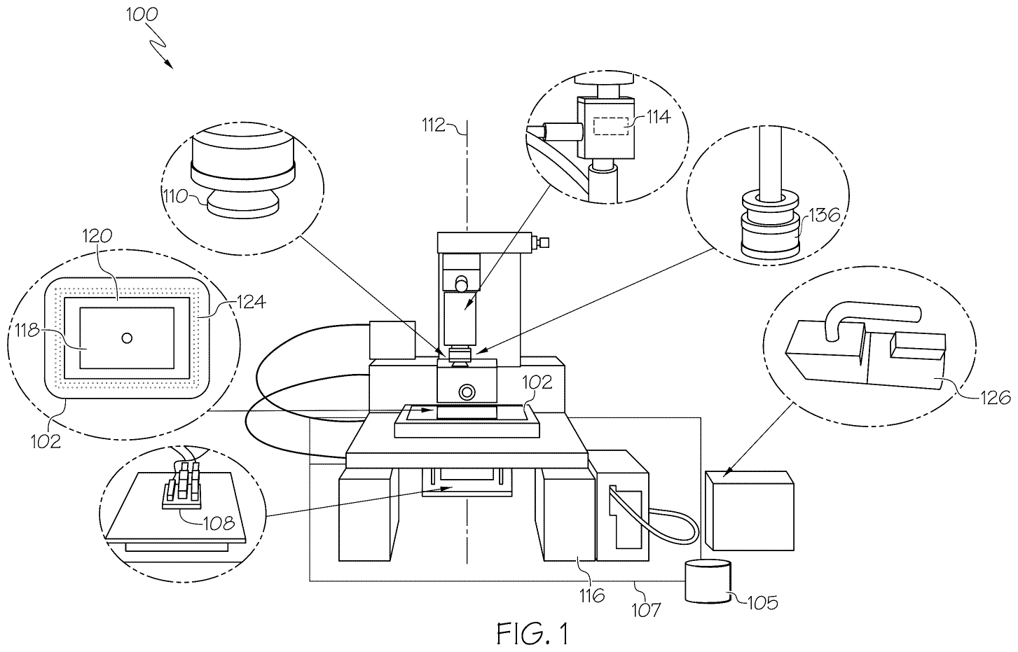

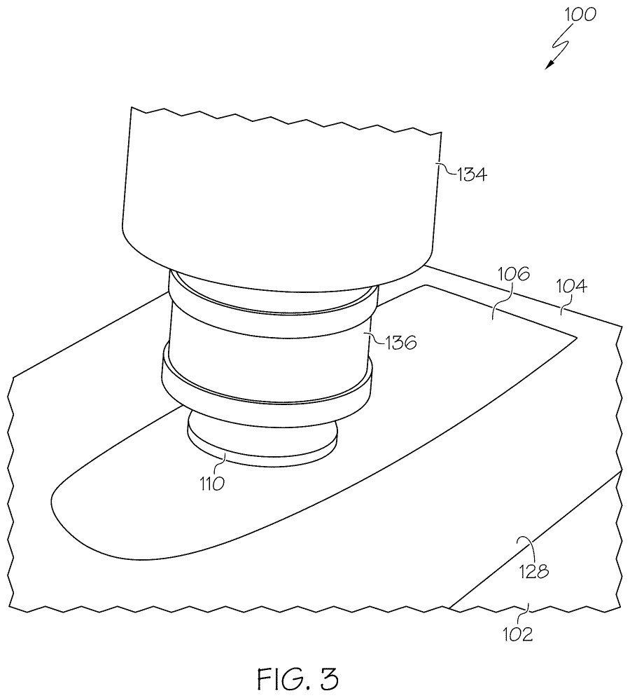

Referring now to FIGS. 1-3, an additive manufacturing testing apparatus 100 is illustrated according to one or more embodiments described herein. The additive manufacturing testing apparatus 100 may generally include an interchangeable base plate 102, an interchangeable dolly 110, and a sensor 114.

The interchangeable base plate 102 may comprise a transparent section 118 over which the photocurable material 106 is disposed. For example, in embodiments, the photocurable material 106 may disposed directly on the transparent section 118 of the interchangeable base plate 102. In other embodiments, as shown and described in further detail below, the photocurable material 106 may additionally be disposed over an interchangeable transparent substrate 104 disposed on the interchangeable base plate 102. In embodiments, the interchangeable base plate 102 may be positioned on a frame 116 and may be further coupled to the frame 116 for support. In embodiments, the interchangeable base plate 102 may comprise at least one of a polymer, a metal, a ceramic, or a composite.

The transparent section 118 may be transparent to radiant energy such that the photocurable material 106 may be cured. As used herein, the term “transparent” refers to a material that is greater than or equal to 80% transparent to the radiant energy wavelength. For example, in embodiments, the transparent section 118 may comprise at least one of glass, plexiglass, or polydimethylsiloxane (PDMS).

Referring still to FIGS. 1-3, the interchangeable dolly 110 may be positionable between an upper position and a lower position along a vertical axis 112, with respect to the interchangeable base plate 102. In embodiments, the interchangeable dolly 110 may be configured to compress the photocurable material 106 between the transparent section 118 and the interchangeable dolly 110 and configured to retract from the transparent section 118. In other embodiments, as shown and described in further detail below, the interchangeable dolly 110 may be configured to compress the photocurable material 106 between an interchangeable transparent substrate 104 disposed on the interchangeable base plate 102 and the interchangeable dolly 110 and configured to retract from the interchangeable transparent substrate 104 and the transparent section 118 of the interchangeable base plate 102. In embodiments, the interchangeable dolly 110 may be movably coupled to the frame 116.

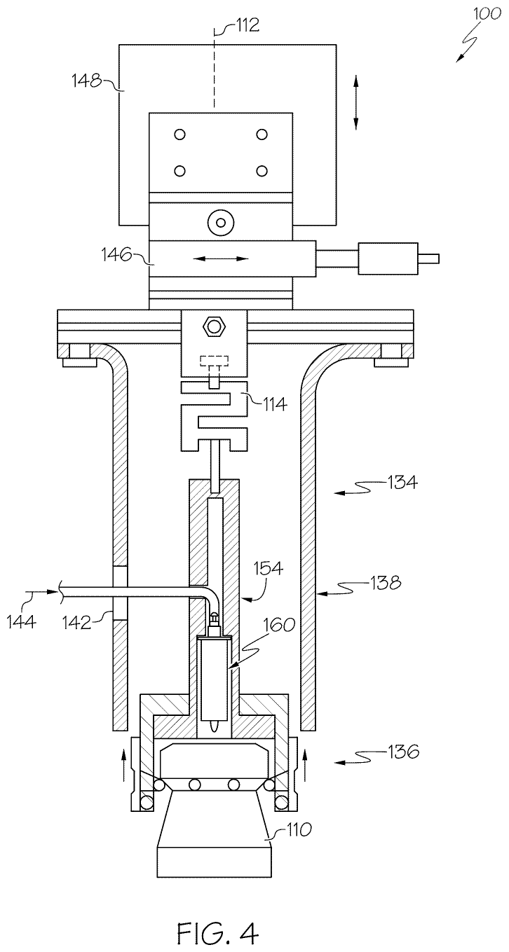

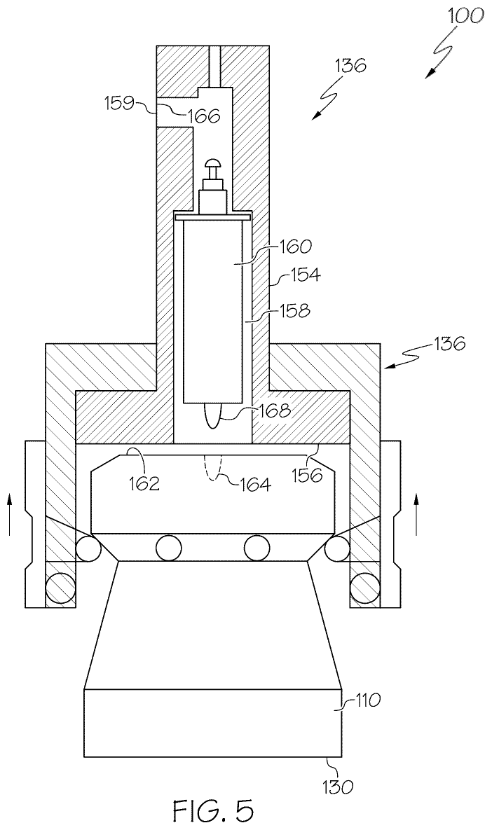

Referring now to FIGS. 4 and 5, in embodiments, a contact surface 130 of the interchangeable dolly 110 that contacts the photocurable material 106 may take the form of various shapes, including but not limited to, a geometric shape, such as a round shape, a square shape, a rectangular shape, an oval shape, a trapezoid shape, or a rhombus shape, an irregular shape, or a comprehensive array of shapes.

In embodiments, the interchangeable dolly 110 may comprise at least one of a plastic material, a metal material, a ceramic material, a silicone material, or a rubber material. The interchangeable dolly 110 may comprise a plastic material, including but not limited to, polycarbonate, a synthetic resin made from the polymerization of vinyl chloride, also referred to herein as polyvinyl chloride (PVC), acrylonitrile-butadiene-styrene (ABS), high density polyethylene (HDPE), polytetrafluoroethylene (PTFE), or polyethylene terephthalate (PET). In some embodiments, the interchangeable dolly 110 may comprise a metal material, including but not limited to, aluminum, steel, or titanium. In other embodiments, the interchangeable dolly 110 may comprise a ceramic material, including but not limited to, alumina, zirconia, porcelain, silicon carbide, or marble. In embodiments, the interchangeable dolly 110 may comprise a silicone material, including but not limited to, polydimethylsiloxane (PDMS) or room-temperature vulcanizing (RTV) silicone. In some embodiments, the interchangeable dolly 110 may comprise a rubber material.

Referring back to FIGS. 1-3, the sensor 114 may be coupled to the interchangeable dolly 110. The sensor 114 may be coupled to the interchangeable dolly 110. The sensor 114 may be configured to measure tensile load and compressive load during movement of the interchangeable dolly 110 between the upper position and the lower position along the vertical axis 112 during compression of the photocurable material 106 and retraction of the interchangeable dolly 110 from the transparent section 118. The sensor 114 may be a load cell, including but not limited to a low load cell to measure low adhesion forces. The data measured by the sensor 114 may be saved in a memory of a computer (not shown).

Referring again to FIGS. 4 and 5, the additive manufacturing testing apparatus 100 may further include a pneumatic actuator 160 that maintains the alignment of the interchangeable dolly 110. The pneumatic actuator 160 may improve parallelism of the interchangeable dolly 110, the sensor 114, and the photocurable material 106 and may improve repeatability. In addition to the pneumatic actuator 160, other alignment mechanisms may include, but are not limited to, a screw, a wedge, or a spring.

The interchangeable dolly 110 utilizing the pneumatic actuator 160 may be loaded into a supporting structure that may be a load train 134. In embodiments, the interchangeable dolly 110 may be coupled to the load train 134 via a quick connect fastener 136. In embodiments, the load train 134 may include a load train safety guard 138 to inhibit lateral defects from harming the sensor 114. The pneumatic actuator 160 may lock in alignment of the interchangeable dolly 110. The load train safety guard 138 may include an aperture 142 for receiving an air supply 144 to power the pneumatic actuator 160.

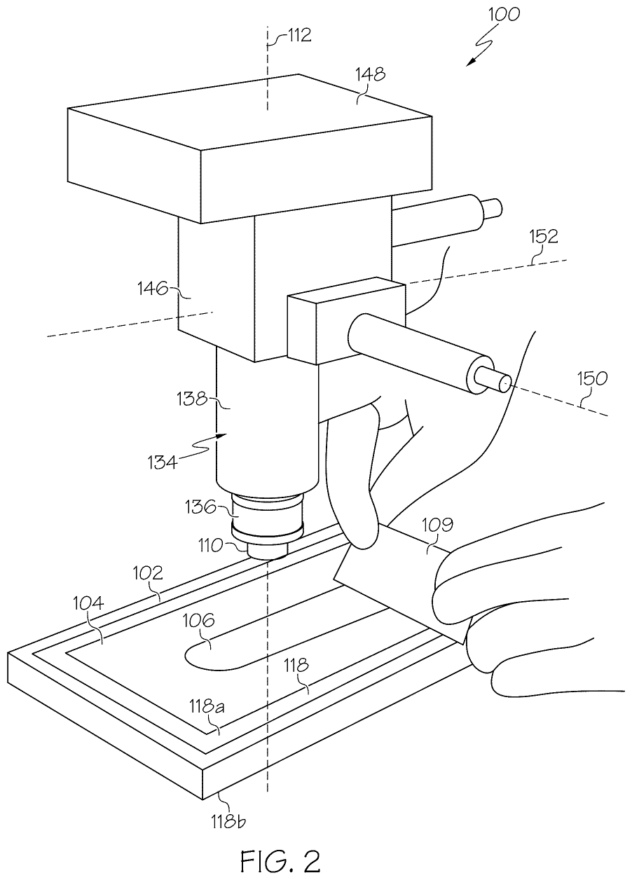

Referring specifically to FIGS. 2 and 4, the load train safety guard 138 may be coupled to a first stage 146 and the first stage 146 may be coupled to a mounting block 148. The first stage 146 may be a two-axis stage that determines alignment of the load train 134, including the load train safety guard 138 and the components housed within the load train 134, in a plane defined by an X-axis 152 and a Y-axis 150 (shown in FIG. 2) that is parallel with respect to the interchangeable base plate 102. The mounting block 148 may be a motorized one-axis stage that determines alignment of the load train 134, including the load train safety guard 138 and the components housed within it, along the vertical axis 112 with respect to the interchangeable base plate 102.

Referring again to FIGS. 4 and 5, the exemplary quick connect fastener 136 is illustrated. The quick connect fastener 136 may include a pneumatic actuator housing 154 and an interior aperture 158 that houses the pneumatic actuator 160. A flat contact surface 156 may abut a top surface 162 of the interchangeable dolly 110. In embodiments, the top surface 162 of the interchangeable dolly 110 may further include an alignment receiving hole 164 to receive a nipple 168 of the pneumatic actuator 160 that couples the interchangeable dolly 110 to the pneumatic actuator housing 154 during activation of the pneumatic actuator 160. The interior aperture 158 within the pneumatic actuator housing 154 may extend through to an outer surface 159 via an aperture 166 through which the air supply 144 for the pneumatic actuator 160 flows. During a deactivation of the pneumatic actuator 160, the interchangeable dolly 110 may be releasable from the quick connect fastener 136.

In embodiments, the sensor 114 may measure tensile load and compressive load of uncured photocurable material 106 (FIGS. 1-3). In other embodiments, referring back to FIGS. 1-3, the transparent section 118 may comprise a first surface 118a and a second surface 118b. The additive manufacturing testing apparatus 100 may further comprise a projector 108 positioned adjacent to a second surface 118b the transparent section 118 of the interchangeable base plate 102. The projector 108 may be configured to project radiant energy through the second surface 118b of transparent section 118 to cure the photocurable material 106 disposed over the first surface 118a of the transparent section 118. That is, in such embodiments, the sensor 114 may measure tensile load and compressive load during curing of a photocurable material. The phrase, “measuring tensile and compressive load during curing of a photocurable material” refers to the entire curing process and, as such, measuring loads before, during, and after the curing event itself. The projector 108 may be coupled to the frame 116.

The radiant energy may be projected in the shape of a pattern. In embodiments, the additive manufacturing testing apparatus 100 may further comprise an interchangeable mask 120 through which the radiant energy is projected. The interchangeable mask 120 may be disposed adjacent to the second surface 118b of the transparent section 118 between the interchangeable base plate 102 and the projector 108 and may determine a size and a shape of the radiant energy projected through it. In other embodiments, light may be projected onto a Digital Light Processing (DLP) chip.

In embodiments, the projector 108 may emit radiant energy from a light emitting diode (LED), liquid crystal display (LCD), a stereolithography laser (SLA), an infrared (IR) lamp, an ultraviolet (UV) lamp, or a visible lamp. The projector 108 may generate a light projection or a light pulse to cure the photocurable material 106 after the interchangeable dolly 110 contacts and compresses the photocurable material 106. In embodiments, the radiant energy may comprise a power density greater than or equal to 1 mW/cm² to 500 mW/cm², greater than or equal to 1 mW/cm² to 250 mW/cm², greater than or equal to 1 mW/cm² to 100 mW/cm², greater than or equal to 1 mW/cm² to 50 mW/cm², greater than or equal to 10 mW/cm² to 500 mW/cm², greater than or equal to 10 mW/cm² to 250 mW/cm², greater than or equal to 10 mW/cm² to 100 mW/cm², greater than or equal to 10 mW/cm² to 50 mW/cm², greater than or equal to 25 mW/cm² to 500 mW/cm², greater than or equal to 25 mW/cm² to 250 mW/cm², greater than or equal to 25 mW/cm² to 100 mW/cm², greater than or equal to 25 mW/cm² to 50 mW/cm², greater than or equal to 50 mW/cm² to 500 mW/cm², greater than or equal to 50 mW/cm² to 250 mW/cm², greater than or equal to 50 mW/cm² to 100 mW/cm², greater than or equal to 100 mW/cm² to 500 mW/cm², greater than or equal to 100 mW/cm² to 250 mW/cm², or even greater than or equal to 250 mW/cm² to 500 mW/cm², or any and all sub-ranges formed from any of these endpoints.

Referring again to FIGS. 1-3, the additive manufacturing testing apparatus 100 may further comprise the interchangeable transparent substrate 104 disposed on the interchangeable base plate 102. The photocurable material 106 may be disposed over the interchangeable transparent substrate 104. For example, in embodiments, the photocurable material 106 may be disposed directly on the interchangeable transparent 104 substrate and may be disposed over the interchangeable base plate 102. In such embodiments, the interchangeable dolly 110 may be configured to compress the photocurable material 106 between the interchangeable transparent substrate 104 disposed on the interchangeable base plate 102 and the interchangeable dolly 110 and configured to retract from the interchangeable transparent substrate 104. In other embodiments that do not include the interchangeable transparent substrate 104, as described herein, the photocurable material 106 may be disposed over the transparent section 118 of the interchangeable base plate 102, such as disposed directly on the transparent section 118 of the interchangeable base plate 102.

In embodiments, the interchangeable transparent substrate 104 may be coupled to the interchangeable base plate 102 by, for example, at least one of a clamp, an adhesive, a vacuum, or a tensioning roller device. For example, the interchangeable base plate 102 may include vacuum chucks 124 that are part of a vacuum system including a vacuum pump 126 for holding down the interchangeable transparent substrate 104.

The interchangeable transparent substrate 104 may be transparent to radiant energy such that the projector 108 may project radiant energy therethrough and cure the photocurable material 106, when desired. In embodiments, the interchangeable transparent substrate 104 may comprise, for example, but not limited to, at least one of polypropylene, polytetrafluoroethylene (PTFE), polycarbonate, or polyethylene terephthalate (PET).

In embodiments, the interchangeable transparent substrate 104 may further include a coating 128 disposed thereon. The coating 128 disposed on the interchangeable transparent substrate 104 may comprise at least one of silicone or anti-static material. Commercial embodiments of a silicone coating include, by way of example and not limitation, SAFTOMER™ ST-2000H from Mitsubishi Chemical Group, VueGuard® 941 from Performance Coatings International, and Staticide® from ACL Staticide Inc. Commercial embodiments of the anti-static coating include, by way of example and not limitation, DEHESIVE® products from Waver Chemie AG, SYL-OFF™ products from Dow, and SilForce™ products from Momentive Performance Materials Inc.

In embodiments, the interchangeable transparent substrate 104 may further be treated by an ozone treatment or corona plasma to alter adhesive forces that may occur between the photocurable material 106 and the interchangeable transparent substrate 104.

In embodiments, the interchangeable transparent substrate 104 may be a film. In embodiments, the thickness of the interchangeable transparent substrate 104 may be greater than or equal to 5 microns and less than or equal to 2000 microns, greater than or equal to 5 microns and less than or equal to 1000 microns, greater than or equal to 5 microns and less than or equal to 500 microns, greater than or equal to 5 microns and less than or equal to 100 microns, greater than or equal to 5 microns and less than or equal to 50 microns, greater than or equal to 25 microns and less than or equal to 2000 microns, greater than or equal to 25 microns and less than or equal to 1000 microns, greater than or equal to 25 microns and less than or equal to 500 microns, greater than or equal to 25 microns and less than or equal to 100 microns, greater than or equal to 25 microns and less than or equal to 50 microns, greater than or equal to 50 microns and less than or equal to 2000 microns, greater than or equal to 50 microns and less than or equal to 1000 microns, greater than or equal to 50 microns and less than or equal to 500 microns, greater than or equal to 50 microns and less than or equal to 100 microns, greater than or equal to 100 microns and less than or equal to 2000 microns, greater than or equal to 100 microns and less than or equal to 1000 microns, greater than or equal to 100 microns and less than or equal to 500 microns, greater than or equal to 500 microns and less than or equal to 2000 microns, greater than or equal to 500 microns and less than or equal to 1000 microns, or even greater than or equal to 1000 microns and less than or equal to 2000 microns, or any and all sub-ranges formed from any of these endpoints.

The uncured photocurable material 106 may be disposed over a transparent section 118 of the interchangeable base plate 102 and, in some embodiments including an interchangeable transparent substrate 104, over an upper surface of the interchangeable transparent substrate 104.

The photocurable material 106 may be manually disposed over the interchangeable base plate 102 and, in some embodiments, over the interchangeable transparent substrate 104. Alternatively, the photocurable material 106 may be automatically disposed over the interchangeable base plate 102 and, in some embodiments, over the interchangeable transparent substrate 104. In embodiments where the photocurable material 106 is automatically dispersed, a vat 105 (FIG. 1) containing the uncured photocurable material 106 may be used in communication with a dispersion mechanism 107 (FIG. 1) that dispenses the uncured photocurable material 106 from the vat 105 and receives the unused uncured photocurable material 106 into the vat 105. A doctor blade 109 may be used to engage with a top surface of the photocurable material 106 to form a desired cast layer thickness of the photocurable material 106.

In embodiments, a predetermined thickness of the photocurable material 106, relative to the interchangeable base plate 102 or the interchangeable transparent substrate 104 on which the photocurable material 106 is disposed, may be greater than or equal to 5 microns and less than or equal to 2000 microns, greater than or equal to 5 microns and less than or equal to 1500 microns, greater than or equal to 5 microns and less than or equal to 1000 microns, greater than or equal to 5 microns and less than or equal to 500 microns, greater than or equal to 5 microns and less than or equal to 300 microns, greater than or equal to 5 microns and less than or equal to 150 microns, greater than or equal to 20 microns and less than or equal to 2000 microns, greater than or equal to 20 microns and less than or equal to 1500 microns, greater than or equal to 20 microns and less than or equal to 1000 microns, greater than or equal to 20 microns and less than or equal to 500 microns, greater than or equal to 20 microns and less than or equal to 300 microns, greater than or equal to 20 microns and less than or equal to 150 microns, greater than or equal to 40 microns and less than or equal to 2000 microns, greater than or equal to 40 microns and less than or equal to 1500 microns, greater than or equal to 40 microns and less than or equal to 1000 microns, greater than or equal to 40 microns and less than or equal to 500 microns, greater than or equal to 40 microns and less than or equal to 300 microns, greater than or equal to 40 microns and less than or equal to 150 microns, greater than or equal to 60 microns and less than or equal to 2000 microns, greater than or equal to 60 microns and less than or equal to 1500 microns, greater than or equal to 60 microns and less than or equal to 1000 microns, greater than or equal to 60 microns and less than or equal to 500 microns, greater than or equal to 60 microns and less than or equal to 300 microns, greater than or equal to 60 microns and less than or equal to 150 microns, greater than or equal to 80 microns and less than or equal to 2000 microns, greater than or equal to 80 microns and less than or equal to 1500 microns, greater than or equal to 80 microns and less than or equal to 1000 microns, greater than or equal to 80 microns and less than or equal to 500 microns, greater than or equal to 80 microns and less than or equal to 300 microns, greater than or equal to 80 microns and less than or equal to 150 microns, greater than or equal to 100 microns and less than or equal to 2000 microns, greater than or equal to 100 microns and less than or equal to 1500 microns, greater than or equal to 100 microns and less than or equal to 1000 microns, greater than or equal to 100 microns and less than or equal to 500 microns, greater than or equal to 100 microns and less than or equal to 300 microns, or even greater than or equal to 100 microns and less than or equal to 150 microns, or any and all sub-ranges formed from any of these endpoints.

In embodiments, the photocurable material 106 may comprise a photocurable resin, including but not limited to, at least one of an acrylate, an epoxy, or a siloxane. In embodiments, the photocurable material 106 may further include, but is not limited to, at least one of a photoinitiator, a light absorbing agent, polymer particles, ceramic particles, metal particles, non-reactive fluid including a solvent or a diluent, or a rheology modifier.

In embodiments in which the photocurable material 106 is cured, such as in embodiments including the projector 108, the cured thickness of the cured photocurable material 106 may be greater than or equal to 5 microns and less than or equal to 1000 microns, greater than or equal to 5 microns and less than or equal to 800 microns, greater than or equal to 5 microns and less than or equal to 600 microns, greater than or equal to 5 microns and less than or equal to 400 microns, greater than or equal to 5 microns and less than or equal to 200 microns, greater than or equal to 5 microns and less than or equal to 150 microns, greater than or equal to 5 microns and less than or equal to 100 microns, greater than or equal to 5 microns and less than or equal to 75 microns, greater than or equal to 5 microns and less than or equal to 50 microns, greater than or equal to 25 microns and less than or equal to 1000 microns, greater than or equal to 25 microns and less than or equal to 800 microns, greater than or equal to 25 microns and less than or equal to 600 microns, greater than or equal to 25 microns and less than or equal to 400 microns, greater than or equal to 25 microns and less than or equal to 200 microns, greater than or equal to 25 microns and less than or equal to 150 microns, greater than or equal to 25 microns and less than or equal to 100 microns, greater than or equal to 25 microns and less than or equal to 75 microns, greater than or equal to 25 microns and less than or equal to 50 microns, greater than or equal to 50 microns and less than or equal to 1000 microns, greater than or equal to 50 microns and less than or equal to 800 microns, greater than or equal to 50 microns and less than or equal to 600 microns, greater than or equal to 50 microns and less than or equal to 400 microns, greater than or equal to 50 microns and less than or equal to 200 microns, greater than or equal to 50 microns and less than or equal to 150 microns, greater than or equal to 50 microns and less than or equal to 100 microns, greater than or equal to 50 microns and less than or equal to 75 microns, greater than or equal to 75 microns and less than or equal to 1000 microns, greater than or equal to 75 microns and less than or equal to 800 microns, greater than or equal to 75 microns and less than or equal to 600 microns, greater than or equal to 75 microns and less than or equal to 400 microns, greater than or equal to 75 microns and less than or equal to 200 microns, greater than or equal to 75 microns and less than or equal to 150 microns, greater than or equal to 75 microns and less than or equal to 100 microns, greater than or equal to 100 microns and less than or equal to 1000 microns, greater than or equal to 100 microns and less than or equal to 800 microns, greater than or equal to 100 microns and less than or equal to 600 microns, greater than or equal to 100 microns and less than or equal to 400 microns, greater than or equal to 100 microns and less than or equal to 200 microns, or even greater than or equal to 100 microns and less than or equal to 150 microns, or any and all sub-ranges for from any of these endpoints.

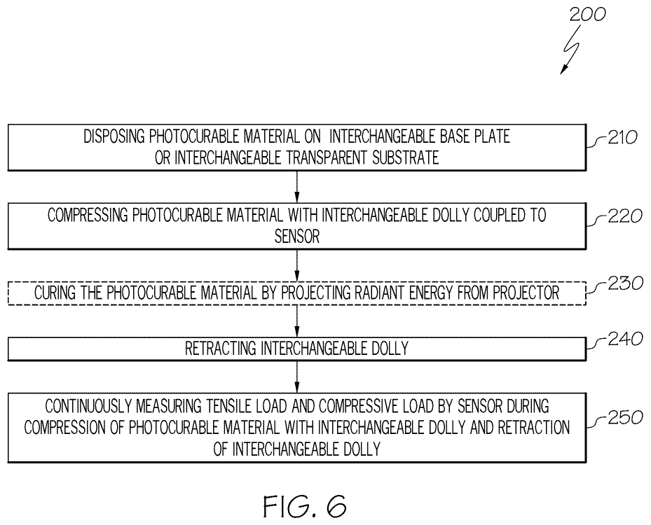

Referring now to FIG. 6, a method 200 of measuring tensile and compressive load of a photocurable material 106 is depicted with reference to FIGS. 1-5. The method 200 may begin at block 210 with disposing a photocurable material 106 on an interchangeable base plate 102 or, in embodiments including an interchangeable transparent substrate 104, on the interchangeable transparent substrate 104. The photocurable material 106 may be disposed to a predetermined thickness relative to the interchangeable base plate 102 or the interchangeable transparent substrate 104.

The method 200 may continue at block 220 with compressing the photocurable material 106 with an interchangeable dolly 110 coupled to a sensor 114 that is configured to measure tensile load and compressive load, as described herein. In embodiments, a rate of displacement as the interchangeable dolly 110 moves towards and into the photocurable material 106 (i.e., compression), relative to the interchangeable base plate 102 or the interchangeable transparent substrate 104, may be greater than or equal to 0.1 micron/second and less than or equal to 10000 microns/second, greater than or equal to 0.1 micron/second and less than or equal to 5000 microns/second, greater than or equal to 0.1 micron/second and less than or equal to 1000 microns/second, greater than or equal to 0.1 micron/second and less than or equal to 500 microns/second, greater than or equal to 0.1 micron/second and less than or equal to 100 microns/second, greater than or equal to 0.1 micron/second and less than or equal to 50 microns/second, greater than or equal to 0.1 micron/second and less than or equal to 10 microns/second, greater than or equal to 1 micron/second and less than or equal to 10000 microns/second, greater than or equal to 1 micron/second and less than or equal to 5000 microns/second, greater than or equal to 1 micron/second and less than or equal to 1000 microns/second, greater than or equal to 1 micron/second and less than or equal to 500 microns/second, greater than or equal to 1 micron/second and less than or equal to 100 microns/second, greater than or equal to 1 micron/second and less than or equal to 50 microns/second, greater than or equal to 1 micron/second and less than or equal to 10 microns/second, greater than or equal to 10 micron/second and less than or equal to 10000 microns/second, greater than or equal to 10 micron/second and less than or equal to 5000 microns/second, greater than or equal to 10 micron/second and less than or equal to 1000 microns/second, greater than or equal to 10 micron/second and less than or equal to 500 microns/second, greater than or equal to 10 micron/second and less than or equal to 100 microns/second, greater than or equal to 10 micron/second and less than or equal to 50 microns/second, greater than or equal to 100 micron/second and less than or equal to 10000 microns/second, greater than or equal to 100 micron/second and less than or equal to 5000 microns/second, greater than or equal to 100 micron/second and less than or equal to 1000 microns/second, greater than or equal to 100 micron/second and less than or equal to 500 microns/second, greater than or equal to 500 micron/second and less than or equal to 10000 microns/second, greater than or equal to 500 micron/second and less than or equal to 5000 microns/second, or even greater than or equal to 500 micron/second and less than or equal to 1000 microns/second, or any and all sub-ranges formed from any of these endpoints.

As described herein, in embodiments, the sensor 114 may measure tensile load and compressive load of the uncured photocurable material 106. Referring back to FIG. 6, the method 200 may optionally continue at block 230 with curing the photocurable material 106 by projecting radiant energy from the projector 108 through the transparent section 118 of the interchangeable base plate 102 and, in some embodiments, interchangeable transparent substrate 104.

The method 200 may further include, retracting the interchangeable dolly 110 from the transparent section 118 of the interchangeable base plate 102 and, in embodiments, the interchangeable transparent substrate 104, as shown at block 240. In embodiments, the rate of retraction of the interchangeable dolly 110 (i.e., tension), relative to the interchangeable base plate 102 or the interchangeable transparent substrate 104, may be greater than or equal to 0.1 micron/second and less than or equal to 10000 microns/second, greater than or equal to 0.1 micron/second and less than or equal to 5000 microns/second, greater than or equal to 0.1 micron/second and less than or equal to 1000 microns/second, greater than or equal to 0.1 micron/second and less than or equal to 500 microns/second, greater than or equal to 0.1 micron/second and less than or equal to 100 microns/second, greater than or equal to 0.1 micron/second and less than or equal to 50 microns/second, greater than or equal to 0.1 micron/second and less than or equal to 10 microns/second, greater than or equal to 1 micron/second and less than or equal to 10000 microns/second, greater than or equal to 1 micron/second and less than or equal to 5000 microns/second, greater than or equal to 1 micron/second and less than or equal to 1000 microns/second, greater than or equal to 1 micron/second and less than or equal to 500 microns/second, greater than or equal to 1 micron/second and less than or equal to 100 microns/second, greater than or equal to 1 micron/second and less than or equal to 50 microns/second, greater than or equal to 1 micron/second and less than or equal to 10 microns/second, greater than or equal to 10 micron/second and less than or equal to 10000 microns/second, greater than or equal to 10 micron/second and less than or equal to 5000 microns/second, greater than or equal to 10 micron/second and less than or equal to 1000 microns/second, greater than or equal to 10 micron/second and less than or equal to 500 microns/second, greater than or equal to 10 micron/second and less than or equal to 100 microns/second, greater than or equal to 10 micron/second and less than or equal to 50 microns/second, greater than or equal to 100 micron/second and less than or equal to 10000 microns/second, greater than or equal to 100 micron/second and less than or equal to 5000 microns/second, greater than or equal to 100 micron/second and less than or equal to 1000 microns/second, greater than or equal to 100 micron/second and less than or equal to 500 microns/second, greater than or equal to 500 micron/second and less than or equal to 10000 microns/second, greater than or equal to 500 micron/second and less than or equal to 5000 microns/second, or even greater than or equal to 500 micron/second and less than or equal to 1000 microns/second, or any and all sub-ranges formed from any of these endpoints.

The method 200 may continue at block 250 with continuously measuring tensile load and compressive load by the sensor 114 during the compression of the photocurable material 106 with the interchangeable dolly 110 and retraction of the interchangeable dolly 110. In embodiments, retraction of the interchangeable dolly 110 may include withdrawal and separation of the uncured photocurable material 106 from the interchangeable base plate 102 or the interchangeable transparent substrate 104. In other embodiments, retraction of the interchangeable dolly may include withdrawal and separation of the cured photocurable material 106 from the interchangeable base plate 102 or the interchangeable transparent substrate 104. In embodiments, retraction of the interchangeable dolly 110 may cause the interchangeable transparent substrate 104 to be displaced, at least temporarily, relative to the interchangeable base plate 102 due to adhesion forces between the uncured or cured photocurable material 106 and the interchangeable dolly 110.

While the above describes a configuration where the displacement of the dolly is controlled and the tensile and compressive loads are measured, one skilled in the art would appreciate that the additive manufacturing testing apparatus described herein may be modified such that the displacement of the dolly is measured and the tensile and compressive loads are controlled.

From the above, it is to be appreciated that defined herein is an additive manufacturing testing apparatus and an additive manufacturing testing method for measuring tensile load and compressive load of a photocurable material. The testing apparatus has multiple interchangeable components that may be interchanged to determine tensile load and compressive load of an uncured or cured photocurable material using those different interchangeable components and further using different photocurable material with different combinations of interchangeable components to test the tensile load and compressive load of the different photocurable materials.

### Examples

Embodiments will be further clarified by the following examples. It should be understood that these examples are not limiting to the embodiments described above.

Example photocurable materials E1, E2, E3, and E4 were subjected to testing on an additive manufacturing testing apparatus as described herein. Example photocurable materials E1-E4 were blends of acrylates with a photoinitiator, rheology modifier, light absorbing agent, and ceramic powders. Example photocurable material E1 was disposed on a rigid glass substrate and tested with a 10 mm interchangeable dolly. Example photocurable material E2 was disposed on a pre-tensioned foil substrate with a 14 mm interchangeable dolly. Example photocurable material E3 was disposed on a pre-tensioned foil substrate with a 10 mm interchangeable dolly. Example photocurable material E4 was disposed on a foil substrate held down by a vacuum with a 10 mm interchangeable dolly.

The example photocurable materials were disposed on the respective substrate of the additive manufacturing testing apparatus to have a 100 micron predetermined thickness. The example photocurable materials were subjected to curing with a projector having a power density of greater than 80 mW/cm² and had a cured thickness of between 25 and 50 microns. The rate of retraction was 100 microns/second.

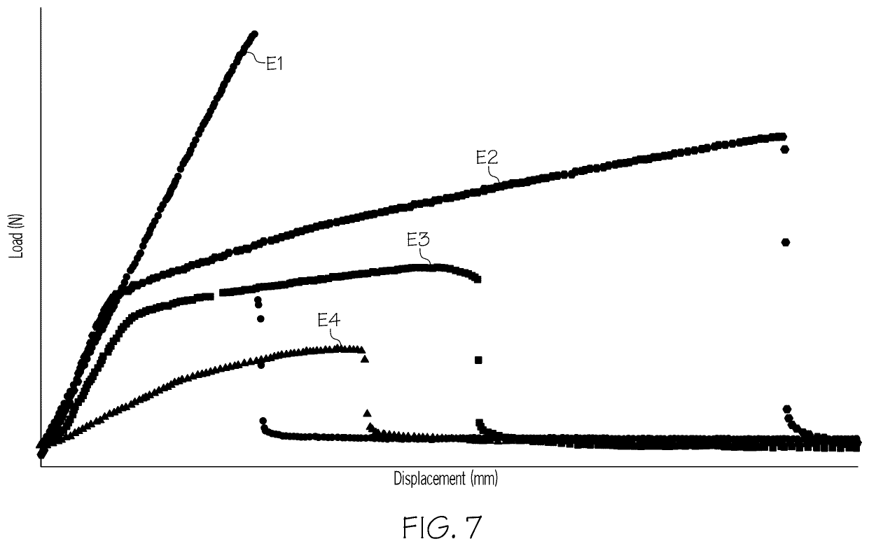

Referring now to FIG. 7, a plot of the load displacement of the interchangeable dolly relative to the substrate is shown. As the interchangeable dolly was retracted, the stress increased in a near-linear fashion, due to the dolly being in contact with the photocurable material, which was still in contact with the substrate. The increasing load and displacement may be indicative of the substrate deflecting and/or the photocurable material elongating. Changes in the slope of the load-displacement line or deviations from non-linearity may be indicative of changing load states between the interchangeable dolly, the photocurable material, and the substrate. The load quickly decreasing near zero is indicative of the photocurable material fully separating from the substrate. More gradual decreases in the load may be indicative of more gradual separation of the photocurable material from the substrate. As exemplified by FIG. 7, the additive manufacturing testing apparatus described herein may be used to measure tensile and compressive loads during curing of a photocurable material.

Further aspects of the embodiments described herein are provided by the subject matter of the following clauses:

An additive manufacturing testing apparatus comprising: an interchangeable base plate comprising a transparent section, the transparent section over which a photocurable material is disposed; an interchangeable dolly positionable between an upper position and a lower position along a vertical axis, the interchangeable dolly configured to compress the photocurable material between the transparent section and the interchangeable dolly and configured to retract from the transparent section; and a sensor coupled to the interchangeable dolly, the sensor configured to measure tensile load and compressive load during movement of the interchangeable dolly between the upper position and the lower position along the vertical axis during compression of the photocurable material and retraction of the interchangeable dolly from the transparent section.

The additive manufacturing testing apparatus of any of the preceding clauses, wherein the transparent section comprises at least one of glass, plexiglass, or polydimethylsiloxane (PDMS).

The additive manufacturing testing apparatus of any of the preceding clauses, the transparent section comprising a first surface and a second surface, the additive manufacturing testing apparatus further comprising a projector positioned adjacent to the second surface of the transparent section of the interchangeable base plate, the projector configured to project radiant energy through the second surface of the transparent section to cure the photocurable material disposed over the first surface of the transparent section.

The additive manufacturing testing apparatus of any of the preceding clauses, wherein the radiant energy is projected in a shape of a pattern.

The additive manufacturing testing apparatus of any of the preceding clauses, further comprising an interchangeable mask through which the radiant energy is projected, wherein the interchangeable mask is disposed adjacent to the second surface of the transparent section between the interchangeable base plate and the projector and determines a size and a shape of the radiant energy projected through it.

The additive manufacturing testing apparatus of any of the preceding clauses, further comprising an interchangeable transparent substrate over which the photocurable material is disposed, the interchangeable transparent substrate being disposed on the interchangeable base plate.

The additive manufacturing testing apparatus of any of the preceding clauses, wherein the interchangeable transparent substrate is coupled to the interchangeable base plate by at least one of a clamp, an adhesive, a vacuum, or a tensioning roller device.

The additive manufacturing testing apparatus of any of the preceding clauses, wherein the interchangeable transparent substrate comprises at least one of polypropylene, polytetrafluoroethylene (PTFE), polycarbonate, or polyethylene terephthalate (PET).

The additive manufacturing testing apparatus of any of the preceding clauses, wherein the interchangeable transparent substrate comprises a coating.

The additive manufacturing testing apparatus of any of the preceding clauses, wherein the coating comprises at least one of a silicone or anti-static material.

The additive manufacturing testing apparatus of any of the preceding clauses, wherein the interchangeable transparent substrate is treated by an ozone treatment or corona plasma.

The additive manufacturing testing apparatus of any of the preceding clauses, wherein a thickness of the interchangeable transparent substrate is greater than or equal to 5 microns and less than or equal to 2000 microns.

The additive manufacturing testing apparatus of any of the preceding clauses, wherein a contact surface of the interchangeable dolly is one of a geometric shape, an irregular shape, or a comprehensive array of shapes.

The additive manufacturing testing apparatus of any of the preceding clauses, wherein the interchangeable dolly comprises at least one of a plastic material, a metal material a ceramic material, a silicone material, or a rubber material.

The additive manufacturing testing apparatus of any of the preceding clauses, wherein the plastic material comprises at least one of polycarbonate, polyvinyl chloride (PVC), acrylonitrile-butadiene-styrene (ABS), high density polyethylene (HDPE), polytetrafluoroethylene (PTFE), or polyethylene terephthalate (PET).

The additive manufacturing testing apparatus of any of the preceding clauses, wherein the metal material comprises at least one of aluminum, steel, or titanium.

The additive manufacturing testing apparatus of any of the preceding clauses, wherein the ceramic material comprises at least one of alumina, zirconia, porcelain, silicon carbide, or marble.

The additive manufacturing testing apparatus of any of the preceding clauses, wherein the silicone material comprises at least one of polydimethylsiloxane (PDMS) or room-temperature vulcanizing (RTV) silicone.

The additive manufacturing testing apparatus of any of the preceding clauses, further comprising a pneumatic actuator that maintains alignment of the interchangeable dolly.

The additive manufacturing testing apparatus of any of the preceding clauses, further comprising a load train, the interchangeable dolly being coupled to the load train via a quick connect fastener, the quick connect fastener comprising a pneumatic actuator housing and an interior aperture that houses the pneumatic actuator.

The additive manufacturing testing apparatus of any of the preceding clauses, wherein the interchangeable dolly further comprises an alignment receiving hole to receive a nipple of the pneumatic actuator.

The additive manufacturing testing apparatus of any of the preceding clauses, wherein the load train further comprises a load train safety guard to inhibit lateral defects to the sensor.

The additive manufacturing testing apparatus of any of the preceding clauses, wherein the load train safety guard further comprises an aperture for receiving an air supply to power the pneumatic actuator.

The additive manufacturing testing apparatus of any of the preceding clauses, wherein the load train safety guard is coupled to a first stage and the first stage is coupled to a mounting block.

The additive manufacturing testing apparatus of any of the preceding clauses, further comprising an alignment mechanism, the alignment mechanism comprising a screw, a wedge, or a spring.

The additive manufacturing testing apparatus of any of the preceding clauses, wherein the photocurable material comprises at least one of an acrylate, an epoxy, or a siloxane.

The additive manufacturing testing apparatus of any of the preceding clauses, wherein the photocurable material further includes a photoinitiator.

The additive manufacturing testing apparatus of any of the preceding clauses, wherein the photocurable material further includes at least one of a light absorbing agent, polymer particles, ceramic particles, metal particles, non-reactive fluid, or a rheology modifier.

The additive manufacturing testing apparatus of any of the preceding clauses, wherein the sensor is a load cell.

A method of measuring tensile load and compressive load of a photocurable material, the method comprising: disposing a photocurable material on an interchangeable base plate; compressing the photocurable material with an interchangeable dolly coupled to a sensor configured to measure tensile load and compressive load; retracting the interchangeable dolly from the interchangeable base plate; and continuously measuring tensile load and compressive load by the sensor during the compression of the photocurable material with the interchangeable dolly and retraction of the interchangeable dolly.

The method of any of the preceding clauses, further comprising disposing the photocurable material on an interchangeable transparent substrate, the interchangeable transparent substrate being disposed on the interchangeable base plate.

The method of any of the preceding clauses, further comprising aligning the interchangeable dolly with the sensor by a pneumatic actuator.

The method of any of the preceding clauses, further comprising curing the photocurable material by projecting radiant energy from a projector.

The method of any of the preceding clauses, further comprising disposing the photocurable material to a predetermined thickness, wherein the predetermined thickness is greater than or equal to 5 microns and less than or equal to 2000 microns.

The method of any of the preceding clauses, wherein a rate of displacement as the interchangeable dolly moves towards and into the photocurable material is greater than or equal to 0.1 micron/second and less than or equal to 10000 microns/second.

The method of any of the preceding clauses, wherein a rate of retraction of the interchangeable dolly is greater than or equal to 0.1 micron/second and less than or equal to 10000 microns/second.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. An additive manufacturing testing apparatus comprising:
an interchangeable base plate comprising a transparent section over which a photocurable material is disposed;
an interchangeable dolly positionable between an upper position and a lower position along a vertical axis, the interchangeable dolly configured to compress the photocurable material between the transparent section and the interchangeable dolly and configured to retract from the transparent section; and
a sensor coupled to the interchangeable dolly, the sensor configured to measure tensile load and compressive load during movement of the interchangeable dolly between the upper position and the lower position along the vertical axis during compression of the photocurable material and retraction of the interchangeable dolly from the transparent section.

2. The additive manufacturing testing apparatus of claim 1, wherein the transparent section comprises at least one of glass, plexiglass, or polydimethylsiloxane (PDMS).

3. The additive manufacturing testing apparatus of claim 1, the transparent section comprising a first surface and a second surface, the additive manufacturing testing apparatus further comprising a projector positioned adjacent to the second surface of the transparent section of the interchangeable base plate, the projector configured to project radiant energy through the second surface of the transparent section to cure the photocurable material disposed over the first surface of the transparent section.

4. The additive manufacturing testing apparatus of claim 3, wherein the radiant energy is projected in a shape of a pattern.

5. The additive manufacturing testing apparatus of claim 3, further comprising an interchangeable mask through which the radiant energy is projected, wherein the interchangeable mask is disposed adjacent to the second surface of the transparent section between the interchangeable base plate and the projector and determines a size and a shape of the radiant energy projected through it.

6. The additive manufacturing testing apparatus of claim 1, further comprising an interchangeable transparent substrate over which the photocurable material is disposed, the interchangeable transparent substrate being disposed on the interchangeable base plate.

7. The additive manufacturing testing apparatus of claim 6, wherein the interchangeable transparent substrate comprises at least one of polypropylene, polytetrafluoroethylene (PTFE), polycarbonate, or polyethylene terephthalate (PET).

8. The additive manufacturing testing apparatus of claim 6, wherein the interchangeable transparent substrate comprises a coating, wherein the coating comprises at least one of silicone or anti-static material.

9. The additive manufacturing testing apparatus of claim 6, wherein the interchangeable transparent substrate is treated by an ozone treatment or corona plasma.

10. The additive manufacturing testing apparatus of claim 6, wherein a thickness of the interchangeable transparent substrate is greater than or equal to 5 microns and less than or equal to 2000 microns.

11. The additive manufacturing testing apparatus of claim 1, wherein a contact surface of the interchangeable dolly is one of a geometric shape, an irregular shape, or a comprehensive array of shapes.

12. The additive manufacturing testing apparatus of claim 1, wherein the interchangeable dolly comprises at least one of a plastic material, a metal material, a ceramic material, a silicone material, or a rubber material, wherein:
the plastic material comprises at least one of polycarbonate, polyvinyl chloride (PVC), acrylonitrile-butadiene-styrene (ABS), high density polyethylene (HDPE), polytetrafluoroethylene (PTFE), or polyethylene terephthalate (PET),
the metal material comprises at least one of aluminum, steel, or titanium,
the ceramic material comprises at least one of alumina, zirconia, porcelain, silicon carbide, or marble, and
the silicone material comprises at least one of polydimethylsiloxane (PDMS) or room-temperature vulcanizing (RTV) silicone.

13. The additive manufacturing testing apparatus of claim 1, further comprising a pneumatic actuator that maintains alignment of the interchangeable dolly.

14. The additive manufacturing testing apparatus of claim 1, wherein the photocurable material comprises at least one of an acrylate, an epoxy, or a siloxane.

15. The additive manufacturing testing apparatus of claim 14, wherein the photocurable material further comprises at least one of a photoinitiator, a light absorbing agent, polymer particles, ceramic particles, metal particles, non-reactive fluid, or a rheology modifier.

16. A method of measuring tensile load and compressive load of a photocurable material, the method comprising:
disposing the photocurable material on an interchangeable base plate;
compressing the photocurable material with an interchangeable dolly coupled to a sensor configured to measure tensile load and compressive load;
retracting the interchangeable dolly from the interchangeable base plate; and
continuously measuring tensile load and compressive load by the sensor during compression of the photocurable material with the interchangeable dolly and retraction of the interchangeable dolly.

17. The method of claim 16, further comprising disposing the photocurable material on an interchangeable transparent substrate, the interchangeable transparent substrate being disposed on the interchangeable base plate.

18. The method of claim 16, further comprising curing the photocurable material by projecting radiant energy from a projector.

19. The method of claim 16, further comprising disposing the photocurable material to a predetermined thickness, wherein the predetermined thickness is greater than or equal to 5 microns and less than or equal to 2000 microns.

20. The method of claim 16, wherein a rate of displacement of the interchangeable dolly as the interchangeable dolly moves towards and into the photocurable material is greater than or equal to 0.1 micron/second and less than or equal to 10000 microns/second, and wherein a rate of retraction of the interchangeable dolly is greater than or equal to 0.1 micron/second and less than or equal to 10000 microns/second.
